(19) United States
(12) Patent Application Publication
(10) Pub. No.: US 2013/0279900 A1
(43) Pub. Date: Oct. 24, 2013

(54) PASSIVE OPTICAL NETWORK SYSTEM, METHOD FOR TRANSMITTING AND RECEIVING OPTICAL SIGNAL THEREOF, AND OPTICAL LINE TERMINAL

(71) Applicants: Jong Deog Kim, Daejeon (KR); Jong Jin Lee, Gwangju (KR); Chang Soo Park, Daejeon (KR)

(72) Inventors: Jong Deog Kim, Daejeon (KR); Jong Jin Lee, Gwangju (KR); Chang Soo Park, Daejeon (KR)

(73) Assignee: Electronics and Telecommunications Research Institute, Daejeon (KR)

(21) Appl. No.: 13/590,537

(22) Filed: Aug. 21, 2012

(30) Foreign Application Priority Data
Apr. 24, 2012 (KR) 10-2012-0042858

(51) Int. Cl. H04J 14/02

(52) U.S. Cl. 398/3

(57) ABSTRACT

An optical line terminal (OLT) of a passive optical network (PON) detects a fault in an optical path configured as a single optical fiber core having an annular shape, divides the optical path into a right path and a left path having bi-directionality based on the fault position in which the fault has occurred, demultiplexes a plurality of downstream optical wavelength signals to be transmitted to at least one optical network terminal (ONT) of each group into an optical wavelength signal of the right path and an optical wavelength signal of the left path according to the position in which the fault has occurred, and outputs the same to at least one of the ONTs of each group.

### CROSS-REFERENCE TO RELATED APPLICATION

This application claims priority to and the benefit of Korean Patent Application No. 10-2012-0042858 filed in the Korean Intellectual Property Office on Apr. 24, 2012, the entire contents of which are incorporated herein by reference.

### BACKGROUND OF THE INVENTION

(a) Field of the Invention

The present invention relates to a passive optical network (PON) system, a method for transmitting and receiving an optical signal thereof, and an optical line terminal, and more particularly, to a method for transmitting and receiving an optical signal to protect a path in the occurrence of an optical path fault in a passive optical network system that is capable of accommodating a plurality of subscribers.

(b) Description of the Related Art

A passive optical network (PON) includes an optical network terminal (ONT) of a subscriber side and an optical line terminal (OLT) controlling the ONT. The PON has a point-to-multipoint (P2MP) communication structure between the OLT and the ONT.

In the P2MP type communication such as the PON, basically, a single OLT corresponding to a wireless operator (or a mobile carrier) divides a single optical line into multiple optical lines through an optical distributor, and multiple ONUs or ONTs are connected to the divided optical lines.

The PON may be classified into a TDMA (time division multiple access)-PON and a WDM (wavelength division multiplexing)-PON according to a transmission scheme of downstream traffic from the OLT and upstream traffic from a subscriber.

In the TDMA-PON communication scheme, a downstream signal from the OLT is broadcast to every ONT, while upstream signals from each ONT are received in the form of a burst packet according to a TDM scheme. In the WDMA-PON scheme, a P2MP optical network allowing for a wavelength division access is configured, and in actuality, P2MP downstream and upstream communication is performed through a particular wavelength allocated to the individual ONTs and the OLT.

For the past decade, traffic demand in the subscriber network has been sharply increased, and traffic per line in the PON has continued to increase from below 622 Mbps to 1.25 Gbps, 2.5 Gbps, and 10 Gbps. Thus, in order to effectively use traffic, it is also required to continuously increase the number of ONUs/ONTs that can be acceptable by the OLT per line. In addition, in order to effectively manage communication operation costs, it is required to lengthen an optical link transmission distance from the prior level of 10 km/20 km to 20 km/40 km or more as specified in the ITU-T SG15 standard. Also, colorless optical transmission/reception methods in which wavelengths used in ONTs/ONUs are determined by the OLT are preferred in the WDM-PON.

In addition, when a particular portion of an optical line is damaged or has a fault in the PON in which the OLT and a plurality of ONTs/ONUs are connected through a single optical line, communication of the plurality of ONTs/ONUs is interrupted. Thus, a method for preventing or minimizing interruption of communication of the plurality of ONTs/ONUs in the occurrence of a fault in the optical line in the PON is required.

### SUMMARY OF THE INVENTION

The present invention has been made in an effort to provide a passive optical network system, a method for transmitting and receiving an optical signal thereof, and an optical line terminal having advantages of accommodating a large number of subscribers per optical line.

The present invention has also been made in an effort to provide a passive optical network system, a method for transmitting and receiving an optical signal thereof, and an optical line terminal having advantages of minimizing interruption of communication of a large number of subscribers when an optical path has a fault.

An exemplary embodiment of the present invention provides a passive optical network (PON) system. The PON system includes an optical line terminal (OLT), a wavelength configurable switch (WCS), at least one optical network terminal (ONT) of each group, and a plurality of wavelength add/drop nodes. When a fault is detected in an optical path configured as a single optical fiber core having an annular shape, the OLT may set a position at which the fault has occurred as a fault position. The WCS may divide the single optical path into a right path and a left path based on the OLT and the fault position based on the OLT, output a plurality of downstream optical wavelength signals from the OLT to the left path and the right path, and combine a plurality of upstream optical wavelength signals from the right path and the left path and output the same to the OLT. The plurality of wavelength add/drop nodes may drop a pertinent downstream optical wavelength signal from among the plurality of downstream optical wavelength signals and transfer the same to at least one ONT of a pertinent group, and add an upstream optical wavelength signal from at least one ONT of the pertinent group to the optical path. The OLT may include: a plurality of transceivers configured to transmit and receive the plurality of upstream and downstream optical wavelength signals; a multiplexer configured to multiplex the plurality of downstream optical wavelength signals; a demultiplexer configured to demultiplex the plurality of upstream optical wavelength signals and output the same to the plurality of transceivers; and a wavelength tunable transceiver configured to transmit and receive upstream and downstream optical wavelength signals having a single wavelength according to the fault position.

The OLT may further include a circulator configured to output the plurality of upstream optical wavelength signals to the demultiplexer and output the downstream optical wavelength signals multiplexed by the multiplexer to the wavelength configurable switch.

The wavelength configurable switch may include first to fourth WDM (wavelength division multiplexing) filters. The first WDM filter may demultiplex the plurality of downstream optical wavelength signals into a downstream optical wavelength signal of the right path and a downstream optical wavelength signals of the left path, and multiplex an upstream optical wavelength signal from the right path and an upstream optical wavelength signal from the left path and output the same to the OLT, according to the fault position. The second WDM filter may output input upstream and downstream optical wavelength signals having a single wavelength according to the fault position. The third WDM filter may multiplex a downstream optical wavelength signal of the right path output from the first WDM filter and the downstream optical wavelength signal having a single wavelength output from the second WDM filter and output the same to the right path, and demultiplex the upstream optical wavelength signal from the right path and output the same to the first and second WDM filters. The fourth WDM filter may multiplex the downstream optical wavelength signal of the left path output from the first WDM filter and the downstream optical wavelength signal having a single wavelength output from the second WDM filter and output the same to the left path, and demultiplex the upstream optical wavelength signal from the left path and output the same to the first and second WDM filters.

The plurality of wavelength add/drop nodes may include n number of wavelength add/drop nodes, and the n number of wavelength add/drop nodes may be positioned in the optical path sequentially in a clockwise direction. Each of the wavelength add/drop nodes may include first and second band pass filters (BPFs), third and fourth BPFs, a first circulator, a second circulator, and a WDM filter. The first and second BPFs allow only downstream and upstream optical wavelength signals having a first wavelength therethrough, respectively. The third and fourth BPFs allow only upstream and downstream optical wavelength signals having a second wavelength that is lower than the first wavelength therethrough, respectively. The first circulator may output a plurality of downstream and upstream optical wavelength signals from an immediately previous wavelength add/drop node to the first BPF, and add upstream and downstream optical wavelength signals reflected from the second BPF to the optical path. The second circulator may output upstream and downstream optical wavelength signals which have not transmitted through the first BPF to a subsequent wavelength add/drop node, and upstream and downstream optical wavelength signals from the subsequent wavelength add/drop node to the fourth BPF. The WDM filter may transfer the downstream optical wavelength signal having the first wavelength which has passed through the first BPF and the downstream optical wavelength signal having the second wavelength which has passed through the fourth BPF to an ONT of a pertinent group.

Each of the wavelength add/drop nodes may further include a third circulator, and the third circulator may output the downstream optical wavelength signal having the first wavelength which has passed through the first BPF to the WDM filter and output the upstream optical wavelength signal having the first wavelength from the WDM filter to the second BPF.

Each of the wavelength add/drop nodes may further include a fourth circulator, and the fourth circulator may output the downstream optical wavelength signal having the second wavelength which has passed through the fourth BPF to the WDM filter and output the upstream optical wavelength signal having the second wavelength from the WDM filter to the third BPF.

The right path and the left path may include a bi-directional optical signal path for transmitting upstream and downstream optical wavelength signals.

Another embodiment of the present invention provides an optical line terminal (OLT) of a passive optical network (PON) system. The OLT may include a controller and a wavelength configurable switch (WCS). The controller may detect a fault in an optical path configured as a single optical fiber core having an annular shape, and set the position in which the fault has occurred as a fault position. The WCS may divide a plurality of downstream optical wavelength signals of the optical path into a downstream optical wavelength signal of a right path and a downstream optical wavelength signal of a left path, and combine upstream optical wavelength signals from the right path and the left path, based on the OLT and the fault position under the control of the OLT.

The OLT may further include a plurality of transceivers, a multiplexer, a demultiplexer, and a wavelength tunable transceiver. The plurality of transceivers may receive upstream optical wavelength signals combined by the WCS, and transmit the plurality of downstream optical wavelength signals. The multiplexer may multiplex the plurality of downstream optical wavelength signals. The demultiplexer may demultiplex the upstream optical wavelength signals combined by the WCS and output the same to the plurality of transceivers. The wavelength tunable transceiver may transmit and receive upstream and downstream optical wavelength signals having a single wavelength according to the fault position.

The OLT may further include a circulator, and the circulator may output the plurality of upstream optical wavelength signals to the demultiplexer and output the downstream optical wavelength signals multiplexed by the multiplexer to the WCS.

Yet another embodiment of the present invention provides a method of transmitting and receiving an optical wavelength signal in a passive optical network (PON). The optical signal transmitting and receiving method may include: detecting a fault in an optical path configured as a single optical fiber core; dividing the optical path into a right path and a left path each having bi-directionality based on the position in which the fault has occurred; and demultiplexing a plurality of downstream optical wavelength signals into an optical wavelength signal of the right path and an optical wavelength signal of the left path according to the position in which the fault has occurred and outputting the same to at least one optical network terminal (ONT) of each group.

The optical signal transmitting and receiving method may further include: multiplexing an upstream optical wavelength signal from the right path and an upstream optical wavelength signal from the left path.

The multiplexing may include: receiving an upstream wavelength signal in a direction opposite to that of the downstream optical wavelength signal from the right path; and receiving an upstream optical wavelength signal in a direction opposite to that of the downstream optical wavelength signal from the left path.

The multiplexing may further include adding an upstream optical wavelength signal of at least one ONT of each group to the right path or the left path.

### BRIEF DESCRIPTION OF THE DRAWINGS

FIG. 1 is a view illustrating a passive optical network (PON) system according to an embodiment of the present invention.

FIGS. 2 and 3 are views illustrating the PON system according to a fault position, respectively.

FIG. 4 is a view illustrating an optical line terminal (OLT) illustrated in FIG.

FIG. 5 is a view illustrating a WCS in FIG. 1.

FIGS. 6 to 9 are views illustrating wavelength selecting characteristics of respective WDM filters of respective WCSs.

FIG. 10 is a view illustrating an example of a wavelength add/drop node in FIG. 1.

FIG. 11 is a view illustrating a method of processing an optical wavelength signal transmitted and received through a right path in the wavelength add/drop node in FIG. 10.

FIG. 12 is a view illustrating a method of processing an optical wavelength signal transmitted and received through a left path in the wavelength add/drop node in FIG. 10.

FIG. 13 is a view illustrating another example of the wavelength add/drop node according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

A passive optical network (PON) system, a method for transmitting and receiving an optical signal thereof, and an optical line terminal (OLT) according to embodiments of the present invention will be described in detail with reference to the accompanying drawings.

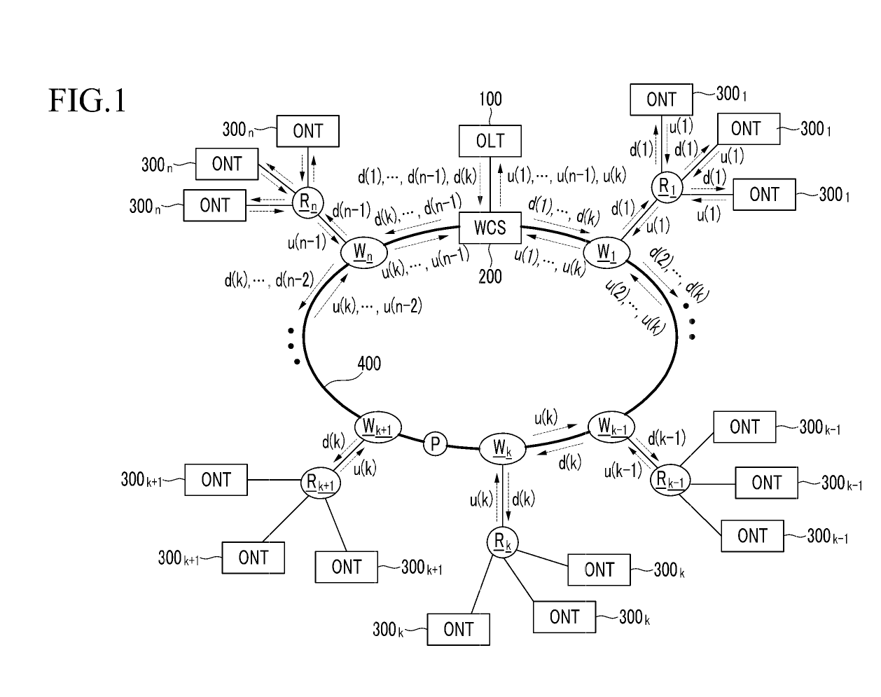

FIG. 1 is a view illustrating a passive optical network (PON) system according to an embodiment of the present invention.

With reference to FIG. 1, the PON system includes an optical line terminal (OLT) 100 of a network, a wavelength configurable switch (WCS) 200, a plurality of wavelength add/drop nodes (W₁-Wₙ), a plurality of remote nodes (R₁-Rₙ), and a plurality of groups of optical network terminals (ONTs) (300₁-300ₙ) of subscribers.

The OLT 100 is connected up to the ONTs (300₁-300ₙ) through a single optical fiber core. The single optical fiber core may form an optical path 400 and include a plurality of optical wavelengths.

The OLT 100 manages and controls the plurality of groups of ONTs (300₁-300ₙ).

The OLT 100 allocates optical wavelengths for transmitting downstream data and upstream data to each group of the ONTs (300₁-300ₙ) managed and controlled by the OLT 100 itself.

The OLT 100 detects whether or not a fault occurs in the annular optical path 400, and when a fault occurs, the OLT 100 sets a fault position P and controls the WCS 200 and the plurality of groups of ONTs (300₁-300ₙ) according to the fault position (P).

The WCS 200 is positioned in the annular optical path 400, and is connected to the OLT 100 through an optical fiber so as to be controlled by the OLT 100. The annular optical path 400 configured as a single optical fiber core is divided into a right path and a left path up to the OLT 100 based on the certain fault position (P). That is, the right path is defined as a path for transferring an optical signal from the fault position (P) up to the OLT 100 through the single optical fiber core in the rightward direction, and the left path is defined as a path for transferring an optical signal from the fault position (P) up to the OLT 100 through the single optical fiber core in the leftward direction.

Under the control of the OLT 100, the WCS 200 divides a plurality of downstream optical wavelength signals into downstream optical wavelength signals for the right path and downstream optical wavelength signals for the left path to output the downstream optical wavelength signals to the right path and the left path, and combines upstream optical wavelength signals from the right path and upstream optical wavelength signals from the left path to transfer the same to the OLT 100. The WCS 200 may be included as a part in the OLT 100. That is, the OLT 100 may perform the function of the WCS 200.

The wavelength add/drop nodes (W₁-Wₙ) are positioned in the optical path, and add or drop a corresponding optical wavelength signal, respectively.

For example, when the fault position (P) in the annular optical path 400 is between the wavelength add/drop node (Wₖ) and the wavelength add/drop node (Wₖ₊₁), the WCS 200 outputs downstream optical wavelength signals [d(1), . . . , d(k)] to be transmitted to the ONT (300₁-300ₖ) to the right path and outputs downstream optical wavelength signals [d(k), . . . , d(n−1)] to be transmitted to the ONT (300ₖ₊₁-300ₙ) to the left path.

The wavelength add/drop nodes (W₁-Wₖ) are positioned in the right path, and drop only a corresponding downstream optical wavelength signal from among the respective downstream optical wavelength signals [d1, . . . , d(k)] and output the dropped downstream optical wavelength signal to the remote nodes (R₁-Rₖ), respectively. Also, the wavelength add/drop nodes (W₁-Wₙ) add the upstream optical signals [u1, . . . , u(k)] from the remote nodes (R₁-Rₖ) for upstream data transmission to the annular optical path 400, and output them toward the OLT 100 through the right path in a transmission direction opposite to that of the downstream optical wavelength signals [d1, . . . , d(k)], respectively. The wavelength add/drop nodes (W₁-Wₙ) are positioned in the left path, and drop only a corresponding downstream optical wavelength signal from among the respective downstream optical wavelength signals [d(k), . . . , d(n−1)] and output the dropped downstream optical wavelength signal to the remote nodes (Rₖ₊₁-Rₙ), respectively. Also, the wavelength add/drop nodes (W₁-Wₙ) add the upstream optical signals [u(k), . . . , u(n−1)] from the remote nodes (Rₖ₊₁-Rₙ) to the annular optical path 400 and output them toward the OLT 100 through the left path in a transmission direction opposite to that of the downstream optical wavelength signals [d(k), . . . , d(n−1)], respectively.

In detail, the wavelength add/drop node (W₁) drops only the optical wavelength signal [d(1)] from among the downstream optical wavelength signals [d1, . . . , d(k)] transmitted through the right path from the WCS 200 and transfers the same toward the remote node (R₁), and transfers the remaining downstream optical wavelength signals [d2, . . . , d(k)] toward the wavelength add/drop node (W₂).

The wavelength add/drop node (W₂) drops only the optical wavelength signal [d(2)] from among the downstream optical wavelength signals [d(2), . . . , d(k)] and transfers the same toward the remote node (R₂) and transfers the other remaining downstream optical wavelength signals [d(3), . . . , d(k)] toward the wavelength add/drop node (W₃). In this manner, the remaining optical wavelength signals [d(3), . . . , d(k)] are sequentially dropped from among the wavelength add/drop nodes (W₃-Wₖ) and transferred toward the remote nodes (R₃-Rₖ).

Also, the wavelength add/drop node (W₁) adds the upstream optical wavelength signal [u(1)] input through the remote node R1 from the ONT (300₁) of the first group to the annular right path, and transfers it in a transmission direction opposite to that of the downstream optical wavelength signals [d(k), . . . , d(n−1)].

The wavelength add/drop node (W₂) adds the upstream optical wavelength signal [u(2)] input through the remote node R1 from the ONT (300₂) of the second group to the annular right path, and transfers it in a transmission direction opposite to that of the downstream optical wavelength signals [d(k), . . . , d(n−1)]. In this manner, the upstream optical wavelength signals [u(3), . . . , u(k)] input through the remote nodes (R₃-Rₖ) from the respective ONTs (300₃-300ₖ) are added to the annular right path by the respective wavelength add/drop nodes (W₃-Wₖ), and transferred in the transmission direction opposite to that of the downstream optical wavelength signals d(k), . . . , d(n−1)] up to the OLT 100.

The wavelength add/drop node (Wₙ) drops only the optical wavelength signal [d(n−1)] from among the downstream optical wavelength signals [d(k), . . . , d(n−1)] output to the left path from the OLT 100, transfers it to toward the remote node (Rₙ), and transfers the remaining downstream optical wavelength signals [d(k), . . . , d(n−2)] toward the wavelength add/drop node (Wₙ₋₁).

The wavelength add/drop node (Wₙ₋₁) drops only the optical wavelength signal [d(n−2)] from among the downstream optical wavelength signals [d(k), . . . , d(n−2)], transfers it to toward the remote node (Rₙ₋₁), and transfers the remaining downstream optical wavelength signals [d(k), . . . , d(n−3)] toward the wavelength add/drop node (Wₙ₋₂). In this manner, the remaining optical wavelength signals [d(k), . . . , d(n−3)] are sequentially dropped from the wavelength add/drop nodes (Wₖ₊₁-Wₙ₋₂) and transferred toward the remote nodes (Rₖ₊₁-Rₙ₋₂), respectively.

Also, the wavelength add/drop node (Wₖ₊₁) adds the upstream optical wavelength signal [u(k)] input through the remote node (Rₖ₊₁) from the respective ONT (300ₖ₊₁) to the annular left path, and transfers it in a transmission direction opposite to that of the downstream optical wavelength signals [d(k), . . . , d(n−1)].

In the same manner, the wavelength add/drop node (Wₖ₊₂) adds the upstream optical wavelength signal [u(k+1)] input through the remote node (Rₖ₊₂) from the ONT (300ₖ₊₂) to the annular left path, and transfers the same in a transmission direction opposite to the downstream optical wavelength signals [d(k), . . . , d(n−1)]. In this manner, the upstream optical wavelength signals [u(k+2), . . . , u(n−1)] input through the remote nodes (Rₖ₊₃-Rₙ) from the respective ONTs (300ₖ₊₃-300ₙ) are also added to the annular left path by the respective wavelength add/drop nodes (Wₖ₊₃-Wₙ) and transferred to the OLT 100.

Thus, in the case of the right path, the i-th upstream/downstream optical wavelength signal is added to/dropped from the i-th wavelength add/drop node W₁, and in the case of the left path, the i-th upstream/downstream optical wavelength signal is added to/dropped from the (i+1)th wavelength add/drop node (W₁₊₁).

The remote nodes (R₁-Rₙ) are connected between the respective wavelength add/drop nodes (W₁-Wₙ) and the ONTs (300₁-300ₙ) of each group through an optical path, and transfer upstream optical wavelength signals from the ONTs (300₁-300ₙ) of each group to the respective wavelength add/drop nodes (W₁-Wₙ) and transfer downstream optical wavelength signals from the respective wavelength add/drop nodes (W₁-Wₙ) to the ONTs (300₁-300ₙ) of each group.

For example, when the fault position (P) is placed in the optical path between the wavelength add/drop node (Wₖ) and the wavelength add/drop node (Wₖ₊₁), the remote nodes (R₁-Rₙ) output the optical wavelength signals [d(1), . . . , d(k), d(k), . . . , d(n−1)] transferred from the wavelength add/drop nodes (W₁-Wₙ) to the ONTs (300₁-300ₙ) and output the optical wavelength signals [u(1), . . . , u(k), u(k), . . . , u(n−1)] transferred from the ONTs (300₁-300ₙ) to the wavelength add/drop nodes (W₁-Wₙ). Thus, the node (Wₖ) and the node (Wₖ₊₁) adjacent to the fault position (P) use the k-th upstream/downstream optical wavelength signals of the same spectrum region each having different data information.

The ONTs (300₁-300ₙ) of each group are connected to the pertinent remote nodes (R₁-Rₙ) through an optical path, and transmit upstream data by using an optical wavelength allocated to each group to which the ONTs (300₁-300ₙ) belong. The optical path from the remote nodes (R₁-Rₙ) to the ONTs (300₁-300ₙ) of each group is different from the annular optical path 400.

The ONTs (300₁-300ₙ) of the same group may transmit upstream data during a time slot allocated thereto according to a TDMA scheme. Here, the ONT 300ᵢ refers to at least one ONT of the i-th group.

In the PON system having such a structure, although a fault occurs in the optical path, the ONTs (300₁-300ₙ) of each group can continue to perform communication.

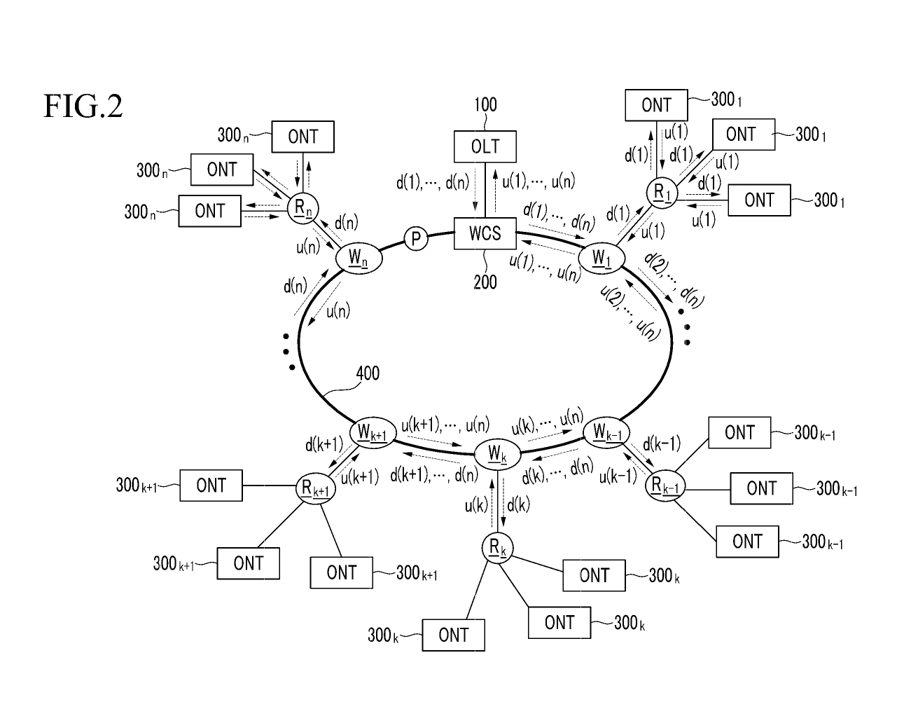

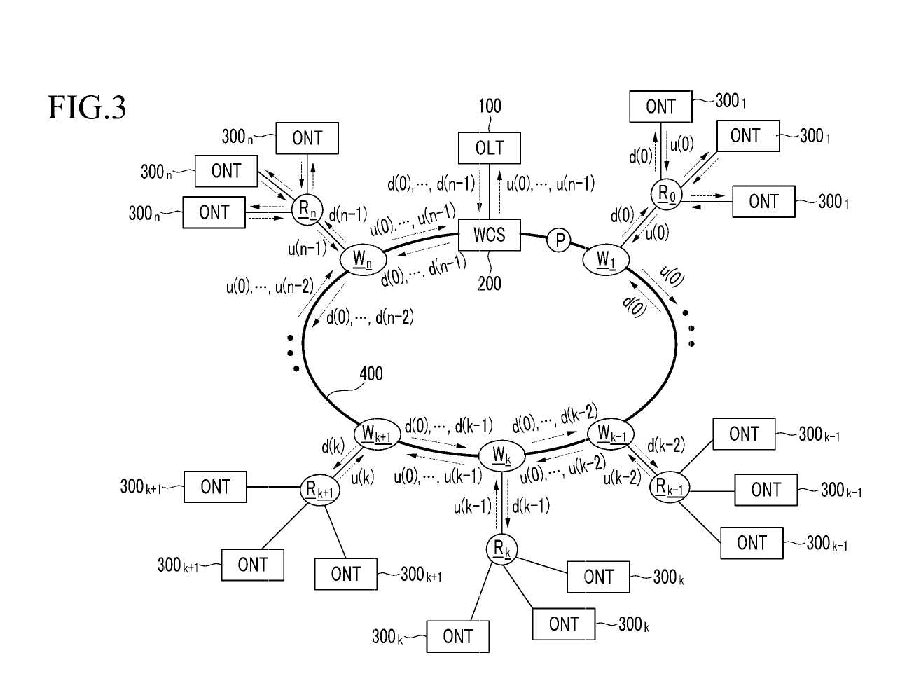

FIGS. 2 and 3 are views illustrating the PON system according to a fault position, respectively.

The fault position (P) resulting from the occurrence of a fault in the PON may be between the OLT 100 and the wavelength add/drop node (Wₙ) as shown in FIG. 2, or may be between the OLT 100 and the wavelength add/drop node (W₁) as shown in FIG. 3.

As shown in FIG. 2, when the fault position (P) is between the OLT 100 and the wavelength add/drop node (Wₙ), all the downstream optical wavelength signals [d(1), . . . , d(n)] from the OLT 100 and all the upstream optical wavelength signals [u(1), . . . , u(n)] from the ONTs (300₁-300ₙ) of each group are transferred through the right path. Here, the upstream optical wavelength signals [u(1), . . . , u(n)] may be transferred in a transmission direction opposite to that of the downstream optical wavelength signals [d(1), . . . , d(n)].

Meanwhile, as shown in FIG. 3, when the fault position (P) is between the OLT 100 and the wavelength add/drop node (W₁), all the downstream optical wavelength signals [d(1), . . . , d(n] and all the upstream optical wavelength signals [u(1), . . . , u(n)] from the ONTs (300₁-300ₙ) of each group are transferred through the left path. Here, the upstream optical wavelength signals [u(1), . . . , u(n)] are transferred in a transmission direction opposite to that of the downstream optical wavelength signals [d(1), . . . , d(n].

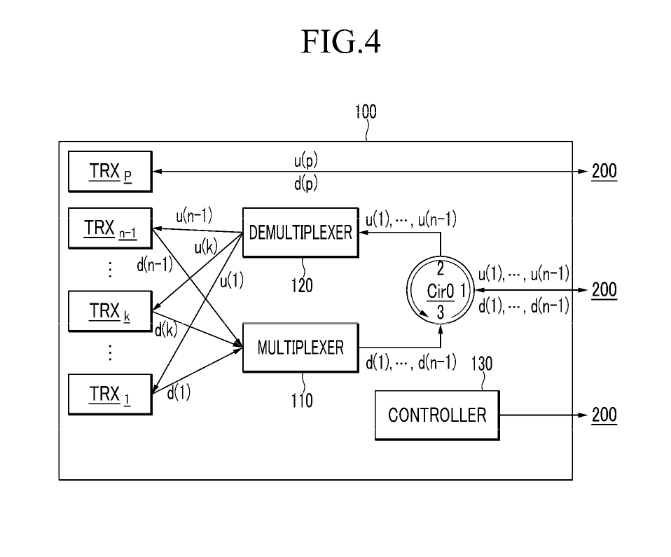

As illustrated in FIGS. 1 to 3, when a fault occurs as an optical fiber is cut, or the like, in a certain position of the annular optical path 400 according to an embodiment of the present invention, the OLT 100 recognizes ONT groups that do not respond to a downstream optical wavelength signal to set a fault position (P), and effectively controls downstream and upstream optical wavelength signals for the right path and the left path, thereby rapidly recovering communication of the overall network. In particular, when there are two or more fault positions in the annular optical path 400, communication for the ONT groups in the right path with respect to a first fault position and the left path with respect to the last fault position in the clockwise direction can be guaranteed. FIG. 4 shows the OLT illustrated in FIG. 1.

With reference to FIG. 4, the OLT 100 includes a plurality of transceivers (TRx₁˜TRxₙ₋₁), a multiplexer 110, a demultiplexer 120, a circulator Cir0, a wavelength tunable transceiver (TRx_{P}), and a controller 130.

The transceivers (TRx₁˜TRxₙ₋₁) transmit and receive pertinent upstream/downstream optical wavelength signals [u(1), . . . , u(n−1)/d(1), . . . , d(n−1)]. In particular, the transceivers (TRx₁˜TRxₙ₋₁) transmit pertinent downstream optical wavelength signals [d(1), . . . , d(n−1)] to the multiplexer 110, and receive pertinent upstream optical wavelength signals [u(1), . . . , u(n−1)], respectively.

The multiplexer 110 multiplexes the downstream optical wavelength signals [d(1), . . . , d(n−1)] received from the transceivers (TRx₁˜TRxₙ₋₁) and outputs the same to the circulator Cir0.

The demultiplexer 120 demultiplexes the upstream optical wavelength signals [u(1), . . . , u(n−1)] received from the circulator Cir0 and outputs respective upstream optical wavelength signals [u(1), . . . , u(n−1)] to the pertinent transceivers (TRx₁˜TRxₙ₋₁).

The circulator Cir0 has three ports 1, 2, and 3, and the three ports 1, 2, and 3 of the circulator Cir0 are disposed to have a circular shape. The port 1 of the circulator Cir0 is connected to the WCS 200, the port 2 of the circulator Cir0 is connected to the demultiplexer 120, and the port 3 of the circulator Cir0 is connected to the multiplexer 110. The circulator Cir0 outputs an optical wavelength signal input through any one of the ports thereof, through a port right next thereto in the proceeding direction. That is, the circulator Cir0 outputs the upstream optical wavelength signals [u(1), . . . , u(n−1)] input through the port 1, to the demultiplexer 120 through the port 2 right next thereto in the proceeding direction, and outputs the downstream optical wavelength signals [d(1), . . . , d(n−1)] input through the port 3 from the multiplexer 110 to the WCS 200 through the port 1 in the proceeding direction.

The wavelength tunable transceiver (TRx_{P}) serves to tune (or vary) a wavelength band, and transmits and receives an upstream/downstream optical wavelength signal having a pertinent wavelength. The wavelength tunable transceiver (TRx_{P}) outputs an upstream/downstream optical wavelength signal [u(p)/d(p)] having a particular single wavelength according to the fault position (P). For example, as shown in FIG. 1, when the fault position (P) is between the wavelength add/drop node (Wₖ) and the wavelength add/drop node (Wₖ₊₁), the wavelength tunable transceiver (TRx_{P}) may transmit and receive upstream/downstream optical wavelength signals [d(k), u(k)]. Meanwhile, as shown in FIG. 2, when the fault position (P) is between the OLT 100 and the wavelength add/drop node (W₁), the wavelength tunable transceiver (TRx_{P}) may transmit and receive upstream/downstream optical wavelength signals [d(n), u(n)]. As shown in FIG. 3, when the fault position (P) is between the OLT 100 and the wavelength add/drop node (W₁), the wavelength tunable transceiver (TRx_{P}) may transmit and receive upstream/downstream optical wavelength signals [d(0), u(0)].

The controller 130 controls the WCS 200 according to the fault position (P).

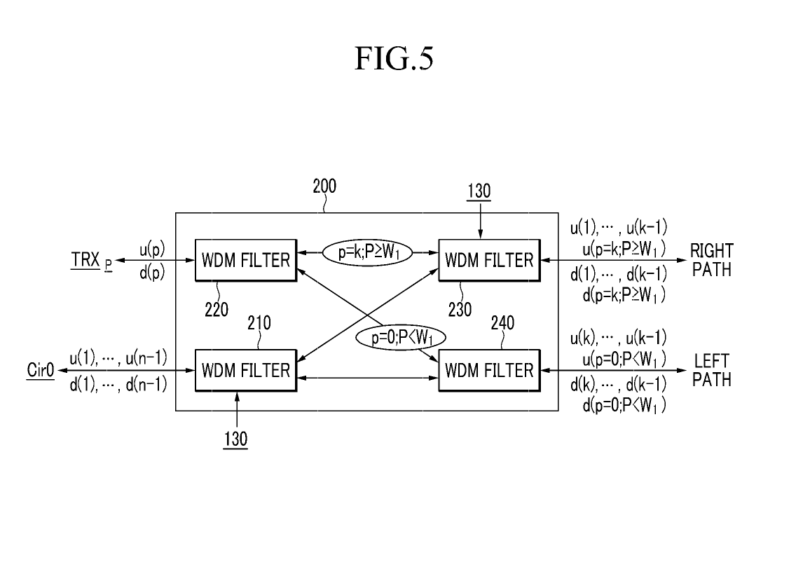

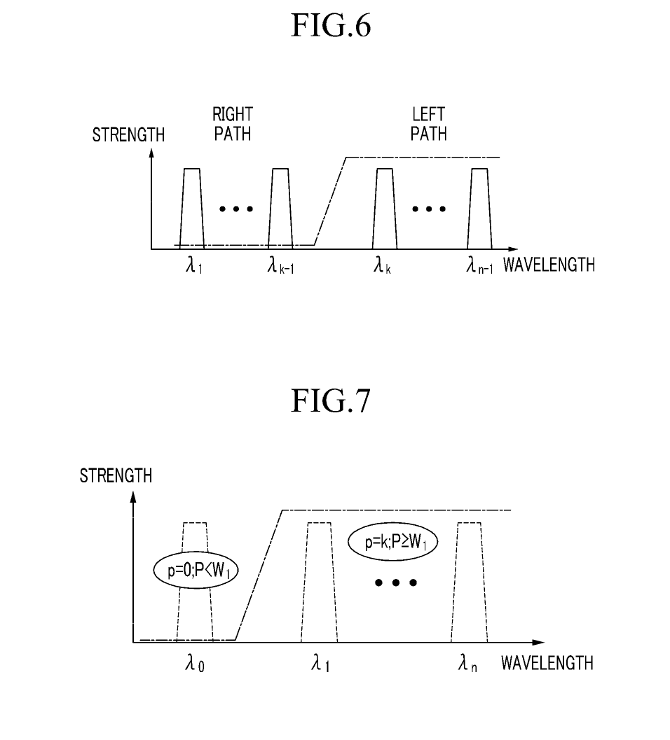

FIG. 5 is a view illustrating a WCS in FIG. 1, and FIGS. 6 to 9 are views illustrating wavelength selecting characteristics of respective WDM filters of respective WCSs.

With reference to FIG. 5, the WCS 200 includes a plurality of wavelength division multiplexing (WDM) filters 210 to 240.

The WDM filter 210 is connected to the circulator Cir0 of the OLT 100, demultiplexes a downstream optical wavelength signal and outputs the same to the WDM filter 230 and/or the WDM filter 240 under the control of the controller 130 of the OLT 100, and multiplexes upstream optical wavelength signals received from the WDM filter 230 and/or the WDM filter 240 and outputs the same to the circulator Cir0 of the OLT 100.

For example, when the fault position (P) is between the wavelength add/drop node (Wₖ) and the wavelength add/drop node (Wₖ₊₁), as shown in FIG. 6, the WDM filter 220 demultiplexes downstream optical wavelength signals into downstream optical wavelength signals having first to (k−1)th wavelengths (λ₁-λₖ₋₁) and multiplexes the upstream optical wavelength signal having first to (k−1)th wavelengths (λ₁-λₖ₋₁) and k-th to (n−1)th wavelength (λₖ-λₙ₋₁).

The WDM filter 220 transfers an optical wavelength signal having a particular wavelength received from the wavelength tunable transceiver (TRx_{P}) to the WDM filter 230 or the WDM filter 240.

As shown in FIG. 7, the WDM filter 220 splits downstream optical wavelength signals into the downstream optical wavelength signals having the 0-th wavelength (λ₀) and first to (n−1)th wavelengths (λ₁˜λₙ₋₁), in the case of k≧1, the WDM filter 220 transfers the downstream optical wavelength signal received from the wavelength tunable transceiver (TRx_{P}) to the WDM filter, and in the case of k<1, i.e., k=1, the WDM filter 220 transfers an optical wavelength signal from the wavelength tunable transceiver (TRx_{P}) to the WDM filter 240.

The WDM filter 230 is connected to the right path, and the WDM filter 240 is connected to the left path.

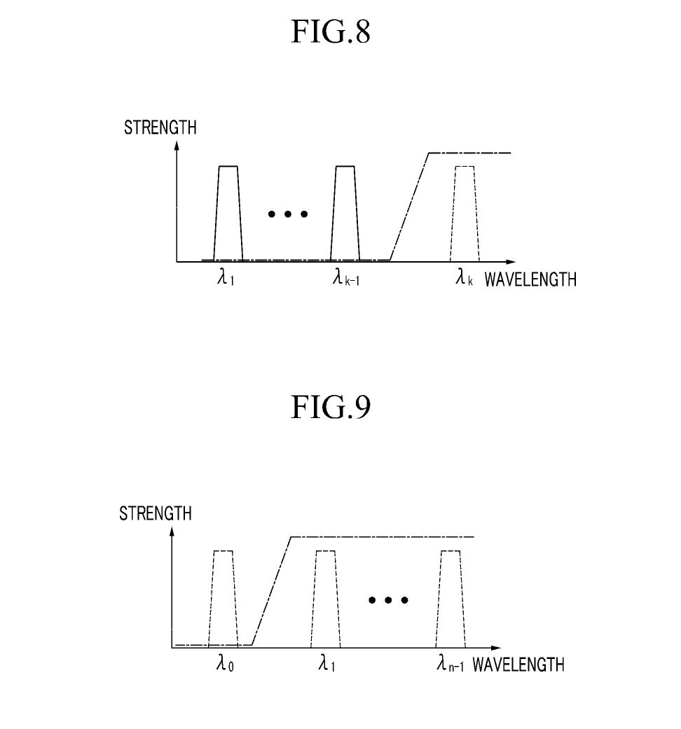

The WDM filter 230 multiplexes downstream optical wavelength signals of the right path transferred from the WDM filters 210 and 220 and outputs the same to the right path, and demultiplexes upstream optical wavelength signals from the right path and transfers the same to the WDM filter 210 and the WDM filter 220, under the control of the controller 130 of the OLT 100. As shown in FIG. 8, the WDM filter 230 demultiplexes the upstream optical wavelength signals from the right path into upstream optical wavelength signals having first to (k−1)th wavelengths (λ₁-λₖ₋₁) and an upstream optical wavelength signal having a k-th wavelength (λₖ), and in the case of k≧1, the WDM filter 230 transfers the upstream optical wavelength signal [u(k)] to the WDM filter 220 and transfers the optical wavelength signals [u(1), . . . , u(k−1)] to the WDM filter 210.

The WDM filter 240 multiplexes the downstream optical wavelength signals of the left path transferred from the WDM filters 210 and 220 and outputs the same to the left path, and demultiplexes upstream optical wavelength signals from the left path and transfers the same to the WDM filter 210 and the WDM filter 220. As shown in FIG. 9, the WDM filter 240 demultiplexes the upstream optical wavelength signals from the left path into upstream optical wavelength signals having 0-th and first to (n−1)th wavelengths (λ₁-λₙ₋₁), and in the case of k=0, the WDM filter 240 transfers the upstream optical wavelength signal [u(0)] to the WDM filter 220 and transfers the optical wavelength signals [u(1), . . . , u(n−1)] to the WDM filter 210.

For example, as shown in FIG. 1, when the fault position (P) is between the wavelength add/drop node (Wₖ) and the wavelength add/drop node (Wₖ₊₁), the WDM filter 210 transfers the downstream optical wavelength signals [d(1), . . . , d(k−1)], among the downstream optical wavelength signals [d(1), . . . , d(n−1)], to the WDM filter 230, and transfers the downstream optical wavelength signals [d(k), . . . , d(n−1)] to the WDM filter 240. The WDM filter 220 receives the downstream optical wavelength signal [d(k)] from the wavelength tunable transceiver (TRx_{P}), and transfers the received downstream optical wavelength signal [d(k)] to the WDM filter 230. The WDM filter 230 combines the downstream optical wavelength signals [d(1), . . . , d(k−1)] transferred from the WDM filter 210 and the downstream optical wavelength signal [d(k)] transferred from the WDM filter 220, and outputs the same to the right path. The WDM filter 240 outputs the downstream optical wavelength signals [d(k), . . . , d(n−1)] transferred from the WDM filter 210 to the left path.

Also, the upstream optical wavelength signals [u(1) u(k)]DeletedTextsfrom the ONTs (300₁-300ₖ) of each group are transmitted to the OLT 100 through the right path, and upstream optical wavelength signals [u(k), . . . , u(n−1)] from the ONTs (300ₖ₊₁-300ₙ) are transmitted to the OLT 100 through the left path. The WDM filter 230 demultiplexes the upstream optical wavelength signals [u(1), . . . , u(k)] from the right path into an upstream optical wavelength signal [u(k)] and upstream optical wavelength signals [u(1), . . . , u(k−1)], transfers the upstream optical wavelength signal [u(k)] to the WDM filter 220, and transfers the optical wavelength signals [u(1), . . . , u(k−1)] to the WDM filter 210. The WDM filter 240 transfers the optical wavelength signals [u(k), . . . , u(n−1)] from the left path to the WDM filter 210. Also, the WDM filter 240 transfers the upstream optical wavelength signals [u(k), . . . , u(n−1)] from the left path to the WDM filter 210. The WDM filter 210 combines the upstream optical wavelength signals [u(1), . . . , u(k−1)] transferred from the WDM filter 230 and the optical wavelength signals [u(k), . . . , u(n−1)] transferred from the WDM filter 240, and outputs the same to the circulator Cir0 of the OLT 100. The WDM filter 220 outputs the upstream optical wavelength signal [u(k)] transferred from the WDM filter 230 to the wavelength tunable transceiver (TRx_{P}) of the OLT 100.

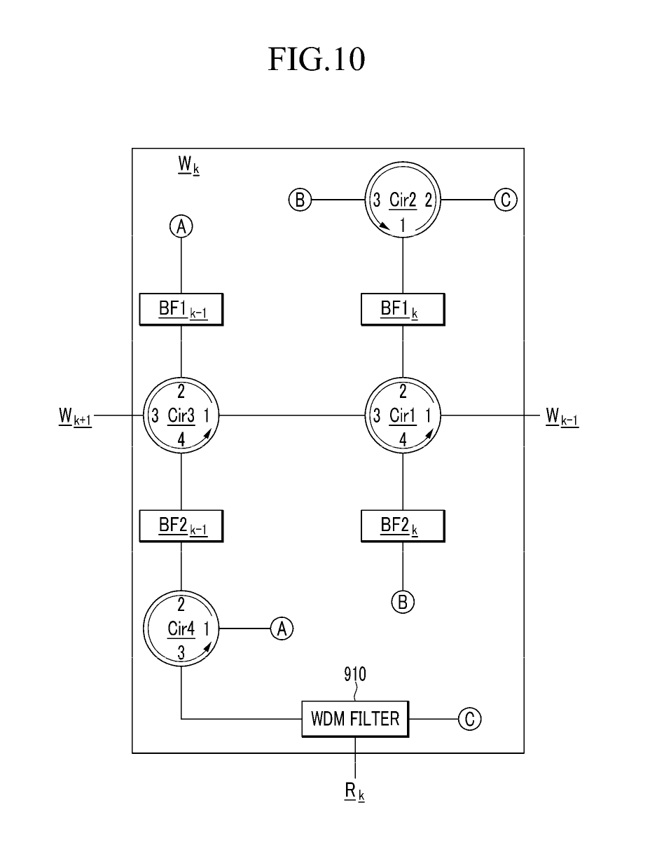

FIG. 10 is a view illustrating an example of a wavelength add/drop node in FIG. 1.

In FIG. 10, for the sake of explanation, the wavelength add/drop node (Wₖ) is illustrated, and the other wavelength add/drop nodes (W₁-Wₖ₋₁, Wₖ₊₁-Wₙ) may also be configured to be identical to the wavelength add/drop node (Wₖ).

With reference to FIG. 10, the wavelength add/drop node (Wₖ) includes a plurality of circulators Cir1-Cir4, a WDM filter 910, and a plurality of BPFs (BF1ₖ, BF2ₖ, BF1ₖ₋₁, BF2ₖ₋₁).

The circulators Cir1 and Cir3 have four ports 1, 2, 3, and 4, and the four ports 1, 2, 3, and 4 of the circulators Cir1 and Cir3 are disposed to have a circular shape. The circulators Cir2 and Cir4 have three ports 1, 2, and 3, and the three ports 1, 2, and 3 of the circulators Cir2 and Cir4 are disposed to have a circular shape.

The port 1 of the circulator Cir1 is connected to the wavelength add/drop node (Wₖ₋₁), and the port 2 of the circulator Cir2 is connected to the BPF (BF1ₖ). The port 3 of the circulator Cir1 is connected to the port 1 of the circulator Cir3, and the port 4 of the circulator Cir1 is connected to the BPF (BF2ₖ).

The port 1 of the circulator Cir2 is connected to the BPF (BF1ₖ), the port 2 of the circulator Cir2 is connected to the WDM filter 910, and the port 3 of the circulator Cir2 is connected to the BPF (BF2ₖ).

The port 1 of the circulator Cir3 is connected to the port 3 of the circulator Cir1, and the port 2 of the circulator Cir3 is connected to the BPF (BF1ₖ₋₁). The port 3 of the circulator Cir3 is connected to the wavelength add/drop node (Wₖ₊₁), and the port 4 of the circulator Cir3 is connected to the BPF (BF2ₖ₋₁).

The port 1 of the circulator Cir4 is connected to the BPF (BF1ₖ₋₁), the port 2 of the circulator Cir2 is connected to the BPF (BF2ₖ₋₁), and the port 3 of the circulator Cir2 is connected to the WDM filter 910.

The circulators Cir1-Cir4 output an optical wavelength signal input through any one port thereof, through a portion right next thereto in a proceeding direction.

Also, the BPFs (BF1ₖ, BF2ₖ) allow only k-th upstream/downstream optical wavelength signals [u(k), d(k)] allocated to the ONT (300ₖ) of a k group, and reflect the otherDeletedTextsupstream/downstream optical wavelength signals. Also, the BPFs (BF1ₖ₋₁, BF2ₖ₋₁) allow only k-th upstream/downstream optical wavelength signals [u(k−1), d(k−1)] allocated to the ONT (300ₖ) of the k group, and reflect the otherDeletedTextsupstream/downstream optical wavelength signals.

The WDM filter 910 has three terminals that are connected to the port 2 of the circulator Cir2, the remote node (Rₖ), and the port 3 of the circulator Cir4 through the three terminals, respectively. The WDM filter 910 selects the k-th upstream/downstream optical wavelength signals [u(k), d(k)] allocated to the ONT (300ₖ) of the k group or the (k+1)th upstream/downstream optical wavelength signals [u(k+1), d(k+1)] from the input upstream/downstream optical wavelength signals, and outputs the same.

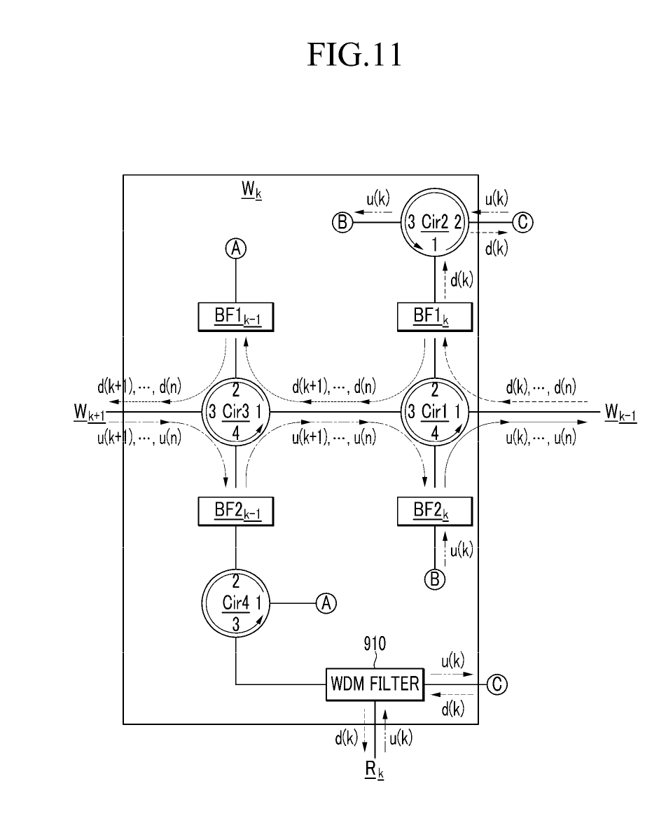

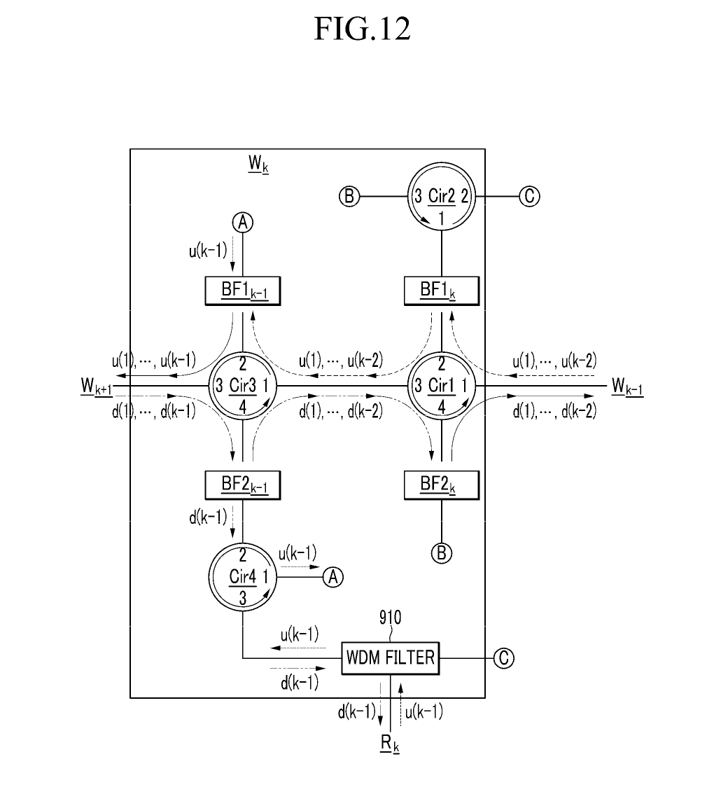

A method of processing upstream/downstream optical wavelength signals in the wavelength add/drop node (Wₖ) configured as described above will be described with reference to FIGS. 11 and 12.

FIG. 11 is a view illustrating a method of processing an optical wavelength signal transmitted and received through a right path in the wavelength add/drop node in FIG. 10, and FIG. 12 is a view illustrating a method of processing an optical wavelength signal transmitted and received through a left path in the wavelength add/drop node in FIG. 10.

First, a method of processing an optical wavelength signal transmitted and received through the right path in the wavelength add/drop node (Wₙ) in the PON system configured as illustrated in FIG. 2 will be described with reference to FIG. 11.

With reference to FIG. 11, when the fault position (P) is between the OLT 100 and the wavelength add/drop node (Wₙ), downstream optical wavelength signals [d(1), . . . , d(n)] pass through the wavelength add/drop nodes (W₁-Wₖ₋₁) through the right path and the downstream optical wavelength signals [d(k), . . . , d(n)] are input to the wavelength add/drop node (Wₖ).

When the downstream optical wavelength signals [d(k), . . . , d(n)] are input through the port 1 of the circulator Cir1 of the wavelength add/drop node (Wₖ), the circulator Cir1 outputs the downstream optical wavelength signals [d(k), . . . , d(n)] to the port 2 right next thereto in the proceeding direction.

The BPF (BF1ₖ) allows only the downstream optical wavelength signal [d(k)], among the downstream optical wavelength signals [d(k), . . . , d(n)] output through the port 2 of the circulator Cir1, to transmit therethrough, and reflects the downstream optical wavelength signals [d(k+1), . . . , d(n)]. The downstream optical wavelength signal [d(k)] which has been transmitted through the BPF (BF1ₖ) is input to the port 1 of the circulator Cir2, and the downstream optical wavelength signals [d(k+1), . . . , d(n)] reflected from the BPF (BF1ₖ) are input again to the port 2 of the circulator Cir2.

The circulator Cir2 outputs the downstream optical wavelength signals [d(k+1), . . . , d(n)] input again to the port 2 to the port 3 right next thereto in the proceeding direction, and the downstream optical wavelength signals [d(k+1), . . . , d(n)] are input to the port 1 of the circulator Cir3.

The circulator Cir2 outputs the downstream optical wavelength signal [d(k)] input again to the port 1 to the port 2 right next thereto in the proceeding direction, and the downstream optical wavelength signal [d(k)] is input to the WDM filter 910.

The WDM filter 910 outputs the downstream optical wavelength signal [d(k)] to the remote node (Rₖ).

Meanwhile, the circulator Cir3 outputs the downstream optical wavelength signals [d(k+1), . . . , d(n)] input through the port 1 to the port 2 right next thereto in the proceeding direction.

The BPF (BF1ₖ) allows only the downstream optical wavelength signal [d(k−1)], among the downstream optical wavelength signals [d(k+1), . . . , d(n)] output through the port 2 of the circulator Cir3, to transmit therethrough, and reflects the downstream optical wavelength signals [d(k+1), . . . , d(n)]. The downstream optical wavelength signals [d(k+1), . . . , d(n)] which have been reflected from the BPF (BF1ₖ₋₁) are input again to the port 2 of the circulator Cir3 so as to be output to the port 3 of the circulator Cir3, and the downstream optical wavelength signals [d(k+1), . . . , d(n)] output through the port 3 of the circulator Cir3 are input to the wavelength add/drop node (Wₖ₊₁).

Through this process, the wavelength add/drop node (Wₖ) drops the downstream optical wavelength signal [d(k)] from the downstream optical wavelength signals [d(1), . . . , d(n)] from the OLT 100, outputs the same to the remote node (Rₖ), and outputs the other remaining downstream optical wavelength signals [d(k+1), . . . , d(n)] to the wavelength add/drop node (Wₖ₊₁).

Also, the upstream optical wavelength signal [u(k)] from the remote node (Rₖ) is input to the WDM filter 910, and the WDM filter 910 outputs the upstream optical wavelength signal [u(k)] to the port 2 of the circulator Cir2.

The circulator Cir2 outputs the upstream optical wavelength signal [u(k)] input through the port 2 to the port 3 right next thereto in the proceeding direction, and the upstream optical wavelength signal [u(k)] output through the port 3 of the circulator Cir2 is input to the BPF (BF2ₖ).

The BPF (BF2ₖ) allows the upstream optical wavelength signal [u(k)] to transmit therethrough, and the upstream optical wavelength signal [u(k)] which has been transmitted through the BPF (BF2ₖ) is input to the port 4 of the circulator Cir1.

Meanwhile, the upstream optical wavelength signals [u(k+1), . . . , u(n)] from the wavelength add/drop node (Wₖ₊₁) are input to the port 3 of the circulator Cir3 of the wavelength add/drop node (Wₖ).

The circulator Cir3 outputs the upstream optical wavelength signals [u(k+1), . . . , u(n)] input through the port 3 to the port 4 right next thereto in the proceeding direction, and the upstream optical wavelength signals [u(k+1), . . . , u(n)] output through the port 4 of the circulator Cir3 are input to the BPF (BF2ₖ₋₁).

The BPF (BF2ₖ₋₁) allows only the optical wavelength signals [d(k−1), u(k−1)] to pass therethrough, so the BPF (BF2ₖ₋₁) reflects all the upstream optical wavelength signals [u(k+1), . . . , u(n)], and accordingly, the upstream optical wavelength signals [u(k+1), . . . , u(n)] are input again to the port 4 of the circulator Cir3 and output to the port 1 right next thereto in the proceeding direction.

The upstream optical wavelength signals [u(k+1), . . . , u(n)] output to the port 1 of the circulator Cir3 are input to the port 3 of the circulator Cir1.

The circulator Cir1 outputs the upstream optical wavelength signals [u(k+1), . . . , u(n)] input through the port 3, through the port 4, and the BPF (BF2ₖ) allows only the optical wavelength signals [d(k), u(k)], so it reflects all the upstream optical wavelength signals [u(k+1), . . . , u(n)]. Thus, the upstream optical wavelength signals [u(k+1), . . . , u(n)] are input again to the port 4 of the circulator Cir1.

The circulator Cir1 combines the upstream optical wavelength signal [u(k)] and the upstream optical wavelength signals [u(k+1), . . . , u(n)] input through the port 4, and outputs the same to the port 1 right next thereto in the proceeding direction. As a result, the upstream optical wavelength signals [u(k), . . . , u(n)] are output to the wavelength add/drop node (Wₖ₋₁) through the port 1 of the circulator Cir1.

Through this process, the wavelength add/drop node (Wₖ) adds the upstream optical wavelength signal [u(k)] from the remote node (Rₖ) to the optical path and outputs the same to the wavelength add/drop node (Wₖ₋₁).

Hereinafter, a method of processing an optical wavelength signal transmitted and received through the left path in the wavelength add/drop node (Wₙ) in the PON system configured as illustrated in FIG. 3 will be described with reference to FIG. 12.

With reference to FIG. 12, when the fault position (P) is between the OLT 100 and the wavelength add/drop node (W₁), the downstream optical wavelength signals [d(0), . . . , d(n−1)] from the OLT 100 pass through the wavelength add/drop nodes (Wₙ-Wₖ₊₁) through the left path and the downstream optical wavelength signals [d(0), . . . , d(k−1)] are input to the wavelength add/drop node (Wₖ).

When the downstream optical wavelength signals [d(0), . . . , d(k−1)] are input through the port 3 of the circulator Cir1 of the wavelength add/drop node (Wₖ), the circulator Cir1 of the wavelength add/drop node (Wₖ) outputs the downstream optical wavelength signals [d(0), . . . , d(k−1)] to the port 4 right next thereto in the proceeding direction.

The BPF (BF2ₖ₋₁) allows only the downstream optical wavelength signal [d(k−1)], among the downstream optical wavelength signals [d(0), . . . , d(k−1)] output through the port 4 of the circulator Cir1, to transmit therethrough, and reflects the downstream optical wavelength signals [d(0), . . . , d(k−2)]. The downstream optical wavelength signal [d(k−1)] which has been transmitted through the BPF (BF2ₖ₋₁) is input to the port 1 of the circulator Cir4, and the downstream optical wavelength signals [d(0), . . . , d(k−2)] reflected from the BPF (BF2ₖ₋₁) are input again to the port 4 of the circulator Cir3.

The circulator Cir3 outputs the downstream optical wavelength signals [d(0), . . . , d(k−2)] input again through the port 4, to the port 1 right next thereto in the proceeding direction, and the output downstream optical wavelength signals [d(0), . . . , d(k−2)] are input to the port 3 of the circulator Cir1.

The circulator Cir4 outputs the downstream optical wavelength signal [d(k−1)] input through the port 1 to the port 2 right next thereto in the proceeding direction, and the downstream optical wavelength signal [d(k−1)] is input to the WDM filter 910.

The WDM filter 910 outputs the downstream optical wavelength signal [d(k−1)] to the remote node (Rₖ).

Meanwhile, the circulator Cir1 outputs the downstream optical wavelength signals [d(0), . . . , d(k−2)] input through the port 3 to the port 4 right next thereto in the proceeding direction.

The BPF (BF2ₖ) allows only the downstream optical wavelength signal [d(k)] to transmit therethrough, so it reflects all the downstream optical wavelength signals [d(0), . . . , d(k−2)] output through the port 4 of the circulator Cir1. The downstream optical wavelength signals [d(0), . . . , d(k−2)] reflected from the BPF (BF1ₖ) are input again to the port 4 of the circulator Cir1 and output to the port 1 of the circulator Cir1. The downstream optical wavelength signals [d(0), . . . , d(k−2)] output through the port 1 of the circulator Cir1 are input to the wavelength add/drop node (Wₖ₋₁).

Through this process, the wavelength add/drop node (Wₖ) drops the downstream optical wavelength signals [d(k−1)] and outputs the same to the remote node (Rₖ), and outputs the remaining downstream optical wavelength signals [d(0), . . . , d(k−2)] to the wavelength add/drop node (Wₖ₋₁).

Also, the upstream optical wavelength signal [u(k−1)] from the remote node (Rₖ) is input to the WDM filter 910, and the WDM filter 910 outputs the upstream optical wavelength signal [u(k−1)] to the port 2 of the circulator Cir4.

The circulator Cir4 outputs the upstream optical wavelength signal [u(k−1)] input through the port 2, to the port 3 right next thereto in the proceeding direction, and the upstream optical wavelength signal [u(k−1)] output through the port 3 of the circulator Cir4 is input to the BPF (BF1ₖ₋₁).

The BPF (BF1ₖ₋₁) allows the upstream optical wavelength signal [u(k−1)] to transmit therethrough, and the upstream optical wavelength signal [u(k−1)] which has been transmitted through the BPF (BF1ₖ₋₁) is input to the port 2 of the circulator Cir3.

Meanwhile, the upstream optical wavelength signals [u(1), . . . , u(k−2)] from the wavelength add/drop node (Wₖ₋₁) are input to the port 1 of the circulator Cir1 of the wavelength add/drop node (Wₖ).

The circulator Cir1 outputs the upstream optical wavelength signals [u(1), . . . , u(k−2)] input through the port 1, to the port 2 right next thereto in the proceeding direction, and the upstream optical wavelength signals [u(1), . . . , u(k−2)] output through the port 2 of the circulator Cir1 are input to the BPF (BF1ₖ).

The BPF (BF1ₖ) allows only the upstream/downstream optical wavelength signals [u(k), d(k)] to pass therethrough, the BPF (BF1ₖ) reflects all the upstream optical wavelength signals [u(1), . . . , u(k−2)], and thus the upstream optical wavelength signals [u(1), . . . , u(k−2)] are input again to the port 2 of the circulator Cir1 and output to the port 3 right next thereto in the proceeding direction.

The upstream optical wavelength signals [u(1), . . . , u(k−2)] output to the port 3 of the circulator Cir1 are input to the port 1 of the circulator Cir3. The circulator Cir3 outputs the upstream optical wavelength signals [u(1), . . . , u(k−2)], which have been input through the port 1, through the port 2, and the BPF (BF1ₖ₋₁) allows only the upstream/downstream optical wavelength signals [u(k−1), d(k−1)], so it reflects all the upstream optical wavelength signals [u(1), . . . , u(k−2)] output through the port 2 of the circulator Cir3. Thus, the upstream optical wavelength signals [u(1), . . . , u(k−2)] are input again to the port 2 of the circulator Cir3.

The circulator Cir3 combines the upstream optical wavelength signal [u(k−1)] and the upstream optical wavelength signals [u(1), . . . , u(k−2)] input through the port 2, and outputs the same to the port 3 right next thereto in the proceeding direction. As a result, the upstream optical wavelength signals [u(1), . . . , u(k−1)] are output to the wavelength add/drop node (Wₖ₊₁) through the port 3 of the circulator Cir3.

Through this process, the wavelength add/drop node (Wₖ) adds the upstream optical wavelength signal [u(k)] from the remote node (Rₖ) to the optical path and outputs the same to the wavelength add/drop node (Wₖ₊₁).

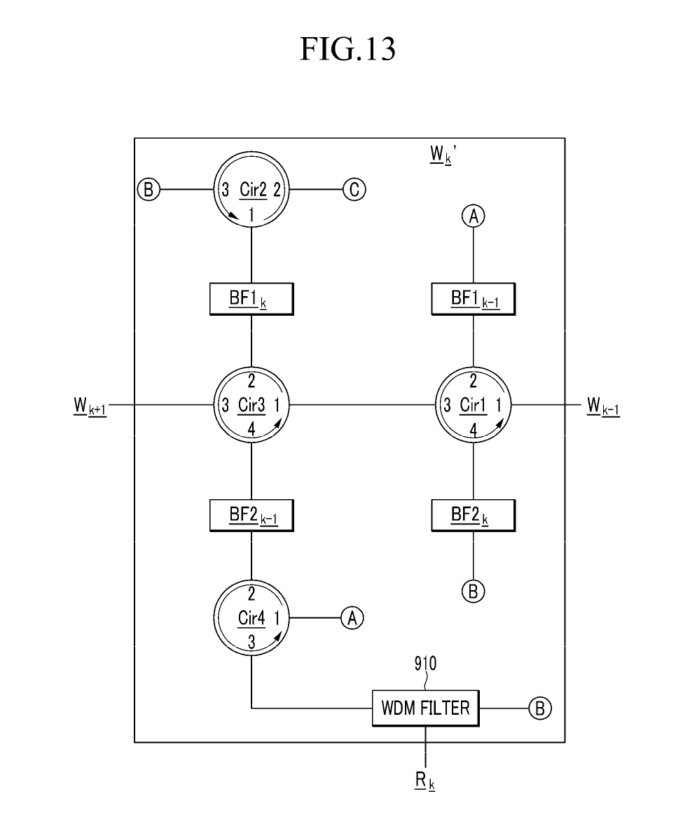

FIG. 13 is a view illustrating another example of the wavelength add/drop node according to an embodiment of the present invention.

With reference to FIG. 13, the BPF (BF1ₖ) of a wavelength add/drop node (Wₖ') is connected to the port 2 of the circulator Cir2, and the BPF (BF1ₖ₋₁) of a wavelength add/drop node (Wₖ₋₁) may be connected to the port 2 of the circulator Cir1. The wavelength add/drop node (Wₖ) having such a structure also processes upstream/downstream optical wavelength signals in the same manner as illustrated in FIGS. 11 and 12.

According to an embodiment of the present invention, since a plurality of wavelengths are used for transmitting upstream and downstream optical signals and a plurality of ONTs are allocated to each wavelength, a larger number of ONTs can be accommodated in a single line of an OLT. For example, by combining eight wavelengths and a 128-way split TDMA-PON per wavelength, a minimum of 1024 ONTs can be accommodated in a single line of an OLT.

Also, when a fault occurs in a particular portion of an optical path in a PON including a large number of ONTs per line of an OLT, a problem in which communication is interrupted in the entire line can be prevented or minimized.

The embodiments of the present invention may not necessarily be implemented only through the foregoing devices and/or methods, but may also be implemented through a program for realizing functions corresponding to the configurations of the embodiments of the present invention, a recording medium including the program, or the like, and such an implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A passive optical network (PON) system, comprising:
an optical line terminal (OLT) that sets a position at which a fault has occurred as a fault position, when the fault is detected in an optical path configured as a single optical fiber core having an annular shape;
a wavelength configurable switch (WCS) configured to divide the single optical path into a right path and a left path based on the OLT and the fault position based on the OLT, output a plurality of downstream optical wavelength signals from the OLT to the left path and the right path, and combine a plurality of upstream optical wavelength signals from the right path and the left path and output the same to the OLT;
at least one optical network terminal (ONT) of each group; and
a plurality of wavelength add/drop nodes configured to drop a pertinent downstream optical wavelength signal from among the plurality of downstream optical wavelength signals and transfer the same to at least one ONT of a pertinent group, and add an upstream optical wavelength signal from at least one ONT of the pertinent group to the optical path.

2. The PON system of claim 1, wherein the OLT comprises:
a plurality of transceivers configured to transmit and receive the plurality of upstream and downstream optical wavelength signals;
a multiplexer configured to multiplex the plurality of downstream optical wavelength signals;
a demultiplexer configured to demultiplex the plurality of upstream optical wavelength signals and output the same to the plurality of transceivers; and
a wavelength tunable transceiver configured to transmit and receive upstream and downstream optical wavelength signals having a single wavelength according to the fault position.

3. The PON system of claim 2, wherein the OLT further comprises
a circulator configured to output the plurality of upstream optical wavelength signals to the demultiplexer and output the downstream optical wavelength signals multiplexed by the multiplexer to the wavelength configurable switch.

4. The PON system of claim 1, wherein the wavelength configurable switch comprises:
a first WDM filter configured to demultiplex the plurality of downstream optical wavelength signals into a downstream optical wavelength signal of the right path and a downstream optical wavelength signals of the left path, and multiplex an upstream optical wavelength signal from the right path and an upstream optical wavelength signal from the left path and output the same to the OLT, according to the fault position;
a second WDM filter configured to output input upstream and downstream optical wavelength signals having a single wavelength according to the fault position;
a third WDM filter configured to multiplex a downstream optical wavelength signal of the right path output from the first WDM filter and the downstream optical wavelength signal having a single wavelength output from the second WDM filter and output the same to the right path, and demultiplex the upstream optical wavelength signal from the right path and output the same to the first and second WDM filters; and
a fourth WDM filter configured to multiplex the downstream optical wavelength signal of the left path output from the first WDM filter and the downstream optical wavelength signal having a single wavelength output from the second WDM filter and output the same to the left path, and demultiplex the upstream optical wavelength signal from the left path and output the same to the first and second WDM filters.

5. The PON system of claim 4, wherein the plurality of wavelength add/drop nodes comprise n number of wavelength add/drop nodes,
the n number of wavelength add/drop nodes are positioned in the optical path sequentially in a clockwise direction, and
when the fault position is between the OLT and a first wavelength add/drop node, the second WDM filter outputs the upstream optical wavelength signal of the single wavelength to the fourth WDM filter, and when the fault position is between one of the second to n-th wavelength add/drop nodes and the OLT, the second WDM filter outputs the upstream optical wavelength signal having the single wavelength to the third WDM filter.

6. The PON system of claim 2, wherein the plurality of wavelength add/drop node comprise n number of wavelength add/drop nodes,
the n number of wavelength add/drop nodes are positioned in the optical path sequentially in a clockwise direction, and
each of the wavelength add/drop nodes comprises:
first and second band pass filters (BPFs) configured to allow only downstream and upstream optical wavelength signals having a first wavelength therethrough, respectively;
third and fourth BPFs configured to allow only upstream and downstream optical wavelength signals having a second wavelength that is lower than the first wavelength therethrough, respectively;
a first circulator configured to output a plurality of downstream and upstream optical wavelength signals from an immediately previous wavelength add/drop node to the first BPF, and add upstream and downstream optical wavelength signals reflected from the second BPF to the optical path;
a second circulator configured to output upstream and downstream optical wavelength signals which have not transmitted through the first BPF to a subsequent wavelength add/drop node, and upstream and downstream optical wavelength signals from the subsequent wavelength add/drop node to the fourth BPF; and
a WDM filter configured to transfer the downstream optical wavelength signal having the first wavelength which has passed through the first BPF and the downstream optical wavelength signal having the second wavelength which has passed through the fourth BPF to an ONT of a pertinent group.

7. The PON system of claim 6, wherein each of the wavelength add/drop nodes further comprises a third circulator configured to output the downstream optical wavelength signal having the first wavelength which has passed through the first BPF to the WDM filter and output the upstream optical wavelength signal having the first wavelength from the WDM filter to the second BPF.

8. The PON system of claim 6, wherein each of the wavelength add/drop nodes further comprises a fourth circulator configured to output the downstream optical wavelength signal having the second wavelength which has passed through the fourth BPF to the WDM filter and output the upstream optical wavelength signal having the second wavelength from the WDM filter to the third BPF.

9. The PON system of claim 2, wherein the right path and the left path comprise a bi-directional optical signal path for transmitting upstream and downstream optical wavelength signals.

10. An optical line terminal (OLT) of a passive optical network (PON) system, the OLT comprising:
a controller configured to detect a fault in an optical path configured as a single optical fiber core having an annular shape, and set the position in which the fault has occurred as a fault position; and
a wavelength configurable switch (WCS) configured to divide a plurality of downstream optical wavelength signals of the optical path into a downstream optical wavelength signal of a right path and a downstream optical wavelength signal of a left path, and combine upstream optical wavelength signals from the right path and the left path, based on the OLT and the fault position under the control of the OLT.

11. The optical line terminal of claim 10, further comprising:
a plurality of transceivers configured to receive upstream optical wavelength signals combined by the WCS, and transmit the plurality of downstream optical wavelength signals;
a multiplexer configured to multiplex the plurality of downstream optical wavelength signals;
a demultiplexer configured to demultiplex the upstream optical wavelength signals combined by the WCS and output the same to the plurality of transceivers; and
a wavelength tunable transceiver configured to transmit and receive upstream and downstream optical wavelength signals having a single wavelength according to the fault position.

12. The optical line terminal of claim 11, further comprising
a circulator configured to output the plurality of upstream optical wavelength signals to the demultiplexer and output the downstream optical wavelength signals multiplexed by the multiplexer to the WCS.

13. The optical line terminal of claim 11, wherein the WCS comprises:
a first WDM filter connected to the right path;
a second WDM filter connected to the left path;
a third WDM filter configured to multiplex or demultiplex optical wavelength signals corresponding to the right path and the left path; and
a fourth WDM filter configured to output an optical wavelength signal having a single wavelength to the first or second WDM filter, or receive the optical wavelength signal having a single wavelength from the first or second WDM filter and output the received optical wavelength signal having a single wavelength to the wavelength tunable transceiver.

14. A method of transmitting and receiving an optical wavelength signal in a passive optical network (PON), the method comprising:
detecting a fault in an optical path configured as a single optical fiber core;
dividing the optical path into a right path and a left path each having bi-directionality based on the position in which the fault has occurred; and
demultiplexing a plurality of downstream optical wavelength signals into an optical wavelength signal of the right path and an optical wavelength signal of the left path according to the position in which the fault has occurred and outputting the same to at least one optical network terminal (ONT) of each group.

15. The method of claim 14, further comprising
multiplexing an upstream optical wavelength signal from the right path and an upstream optical wavelength signal from the left path.

16. The method of claim 15, wherein the multiplexing comprises:
receiving an upstream wavelength signal in a direction opposite to that of the downstream optical wavelength signal from the right path; and
receiving an upstream optical wavelength signal in a direction opposite to that of the downstream optical wavelength signal from the left path.

17. The method of claim 16, wherein the multiplexing further comprises:
adding an upstream optical wavelength signal of at least one ONT of each group to the right path or the left path.

18. The method of claim 14, wherein the optical path comprises a plurality of optical wavelengths, and each optical wavelength is allocated to at least one ONT of each group.

19. The method of claim 16, wherein the outputting comprises dropping an optical wavelength signal corresponding to at least one ONT of each group, from among the optical wavelength signal of the right path and the optical wavelength signal of the left path.
